(19) United States
(12) Patent Application Publication
(10) Pub. No.: US 2005/0288015 A1
(43) Pub. Date: Dec. 29, 2005

(54) Intelligent channel scanning in a wireless network

(76) Inventors: Shahrnaz Azizi, San Diego, CA (US); Jiewen Liu, San Diego, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/877,921

(22) Filed: Jun. 25, 2004

(51) Int. Cl. H04Q 7/20

(52) U.S. Cl. 455/434

(57) ABSTRACT

When scanning for available channels, a wireless mobile device may reduce the number of channels it scans, and therefore reduce the amount of time spent in scanning, by using the information from some of the scanned channels to eliminate the need to scan some of the other channels. In some embodiments in which multiple smaller channels may be combined into larger channels, information gained from one of the smaller channels may show that another smaller channel is associated with it, and thereby eliminate the need to scan that other channel.

### BACKGROUND

In a wireless network, such as a wireless local area network (WLAN), a mobile wireless device may periodically scan through various channels that are potentially available for its use, to determine which channels are currently in use. The information gained from such scanning may allow the mobile wireless device to decide which access point (AP) it is desirable to associate itself with, and/or which channel to use, or if already associated, which other AP it may be desirable to transfer to for reasons of better signal strength, less channel congestion, etc. A mobile wireless device may spend a significant amount of time in this scanning operation (e.g., up to two seconds at a time), during which time it may be unavailable for normal data communications. Such scanning also consumes resources within the mobile wireless device, such as battery power, that would otherwise be available for other uses.

### BRIEF DESCRIPTION OF THE DRAWINGS

The invention may be understood by referring to the following description and accompanying drawings that are used to illustrate embodiments of the invention. In the drawings:

FIG. 1 shows a flow diagram of a method of scanning, according to an embodiment of the invention.

FIG. 2 shows a flow diagram of a method of analyzing channel information to determine if a multi-channel combination is being used, according to an embodiment of the invention.

FIG. 3 shows a diagram of a wireless network in which mobile wireless devices may scan the channels being used by an access point, according to an embodiment of the invention.

FIG. 4 shows a wireless device that may scan for available channels, according to an embodiment of the invention.

### DETAILED DESCRIPTION OF THE INVENTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not.

In keeping with common industry terminology, the terms “base station”, “access point”, and “AP” may be used interchangeably herein to describe an electronic device that may communicate wirelessly and substantially simultaneously with multiple other electronic devices, while the terms “mobile device” and “STA” may be used interchangeably to describe any of those multiple other electronic devices, which may have the capability to be moved and still communicate, though movement is not a requirement. However, the scope of the invention is not limited to devices that are labeled with those terms.

The invention may be implemented in one or a combination of hardware, firmware, and software. The invention may also be implemented as instructions stored on a machine-readable medium, which may be read and executed by a processing platform to perform the operations described herein. A machine-readable medium may include any mechanism for storing, transmitting, or receiving information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive those signals, etc.), and others.

Various embodiments of the invention may reduce scanning time as compared to conventional techniques by using intelligent scanning. Information gained during the scanning process may be used to permit skipping the scanning of some channels. Scanning by a mobile wireless device may comprise monitoring, and/or communicating over, one or more channels to see which channels are active, and to gain information that may be used to determine which APs the mobile wireless device may associate with and which of the active channels may be suitable for that association.

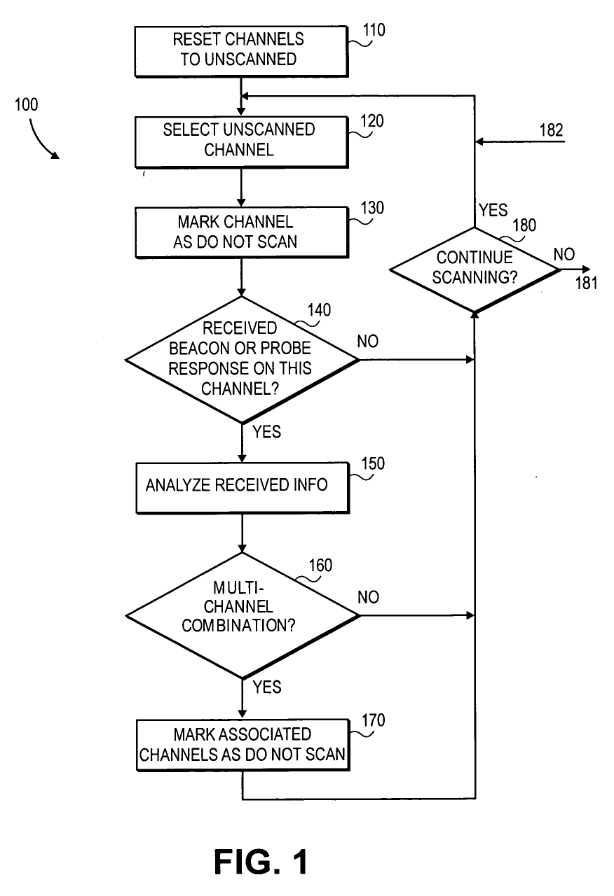

FIG. 1 shows a flow diagram of a method of scanning, according to an embodiment of the invention. In flow diagram 100, indicators of the potentially available channels may be initially reset at 110 to indicate the channels are ‘unscanned’. The channels that are considered potentially available may be determined through any feasible means, such as but not limited to: 1) channels that are allowed by a regulatory agency at that location, 2) channels that are allowed by the technology being used, 3) channels that have been determined by other means to be available for use by devices at this location, and 4) a combination of these and/or other techniques. Providing indicators of potentially available channels may be done through any feasible means, such as by keeping a table of potentially available channels, with an indicator for each channel to show that channel as either ‘unscanned’ or ‘do not scan’. The terms ‘unscanned’ and ‘do not scan’ are used in this description merely as convenient labels, but various embodiments of the invention are not limited to techniques using these labels. These indicators may be used to distinguish between those channels that are still to be investigated and those channels that need not be scanned again (or at all) because sufficient information has already been obtained. A channel may be indicated as ‘do not scan’ because it need not be scanned for various reasons, e.g., because it has already been scanned, because it is associated with a channel that has already been scanned, because it has been removed from consideration for reasons other than those discussed herein, or for other reasons. Because the mobile wireless device may be operating in a dynamic environment, where the channel usage changes with time, the reset exemplified at 110 may be done at intervals to assure that any change in the operating status of previously scanned channels can be detected. Such a reset may also be done on a subset of the potentially available channels.

The interval of the reset may be based on various factors. For example, in a wireless local area network (WLAN) environment where the mobile wireless devices typically remain in one place while being operated (such as a notebook personal computer), an interval of fifteen minutes may be adequate. In an environment where the mobile wireless device may in motion while being operated (such as a PDA in an airport terminal), a one minute interval may be preferable. Irregular triggering events may also precipitate a reset operation. Methods of determining preferred intervals are beyond the scope of this document.

At 120, a channel marked as unscanned may be selected. Channels may be selected by any feasible means, such as but not limited to: 1) selected in a predetermined order, 2) selected randomly, 3) selected based on a dynamically variable criteria, 4) etc. Once a channel has been selected, its indicator may be marked (now at 130, or later) as ‘do not scan’ to indicate that this channel need not be scanned again because the possible suitability of this channel is being, or has already been, investigated. At 140 the mobile wireless device may listen for a beacon message indicating if an AP is operating at this channel, or may solicit information by transmitting a probe request and waiting for a probe response, although various embodiments of the invention may not be limited to these two examples.

Whatever means is used, if the channel is not active or does not provide suitable information, processing may return to 120 to select another channel. The scanning process may also be interrupted and/or discontinued at 180 for various reasons, such as but not limited to: 1) all potentially available channels have been indicated as ‘do not scan’, 2) data communications are pending and have a higher priority than scanning, 3) a pre-set timeout on the scanning process has been reached, 4) a power-related event has occurred, 5) etc. Although the scanning process is shown in FIG. 1 as exiting at 181 and later resuming at 182 at a particular point in the flow diagram, in some embodiments such interruptions to the scanning process may occur at any time and at any point in the flow diagram.

If an active channel was indicated at 140, the information gained from the beacon or probe response may be analyzed at 150. Such analysis may be performed at the indicated point in the process or at another time. If the analysis indicates at 160 that a multichannel combination is being used (e.g., multiple smaller channels are being combined into a single large channel), the indicators for the other channel(s) in this combination may also be marked as ‘do not scan’ at 170. Processing may then return to 120 to begin again with another unscanned channel.

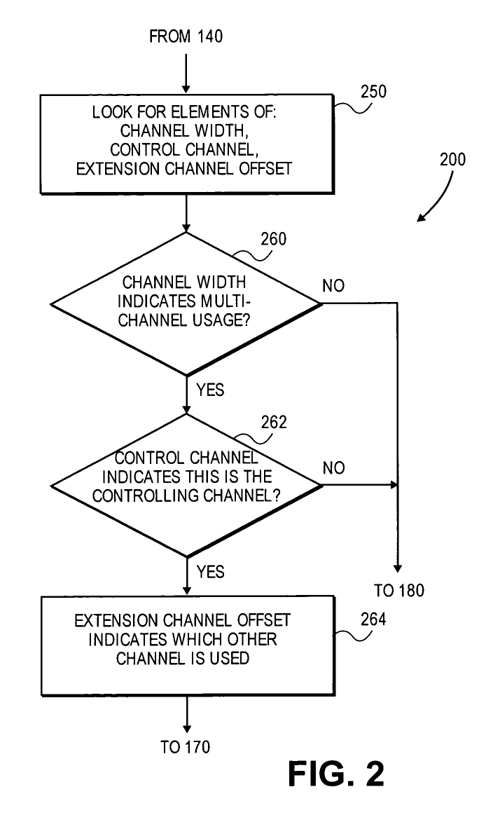

FIG. 2 shows a flow diagram of a method of analyzing channel information to determine if a multi-channel combination is being used, according to an embodiment of the invention. The particular example shown in flow diagram 200 is for a particular embodiment, but other embodiments may vary in their particulars without deviating from the scope of the claimed invention. The illustrated process may be used when two adjacent smaller channels are combined into a single larger channel (the terms ‘smaller’ and ‘larger’ are intended here only to distinguish from each other, and do not imply some measure of absolute size). For example, this technique can permit existing older devices, that can only operate with a 20 Mhz bandwidth (a ‘smaller’ channel), to operate in the same network with newer devices that can operate with a 40 MHz bandwidth (a ‘larger’ channel).

In the specific illustrated embodiment of FIG. 2, with the indicated entry and exit points, block 150 of FIG. 1 may comprise block 250 of FIG. 2, and block 160 of FIG. 1 may comprise blocks 260, 262, 264 of FIG. 2, but other embodiments of the invention may not be limited in this respect, and the processes of FIGS. 1 and 2 may be implemented independently of each other.

At 250, an analysis of a beacon, probe response, or other signal received from, for example, a base station, may obtain information on the channel currently being scanned and may produce relevant information on one or more other channels as well. In a specific embodiment, such an analysis may find information on Channel Width (e.g., whether the channel is a larger channel that combines the bandwidth of two or more smaller channels), Control Channel (e.g., which of the two or more smaller channels carries control information on the larger channel), and Extension Channel Offset (e.g., whether the other associated smaller channel is above or below the current smaller channel in the spectrum, and by how far). At 260 the Channel Width parameter may be examined to determine if multiple smaller channels are being combined into a larger channel. If not, the process may exit without examining the other two parameters in FIG. 2. If the Channel Width parameter indicates the current smaller channel being scanned is part of a larger channel, it may be necessary to determine which other channel(s) is (are) associated with the current channel to form the larger channel. A Control Channel parameter may be examined at 262 to determine if the current smaller channel is the control channel for this combination. If it is, the Extension Channel Offset may be examined at 264 to determine which of the two adjacent smaller channels is being combined with the current smaller channel to form a larger channel. That adjacent channel may then be marked as ‘do not scan’ (for example, see 170 in FIG. 1) because it is linked with a channel that has already been scanned.

If the examination at 262 indicates the current channel is not the control channel, different embodiments may take various paths. In the illustrated embodiment the processing may exit and wait until later when the associated control channel is directly scanned to obtain the relevant information. In other embodiments, if the current (non-control) channel has the relevant information on the associated channel, processing may continue at 264.

Although the previous descriptions may imply that larger channels may be made up of smaller channels that are adjacent to each other (e.g., contiguous in the frequency spectrum), in some embodiments non-adjacent smaller channels may be combined into a larger channel, with the Extension Channel Offset indicating how far away the associated channel is from the current channel.

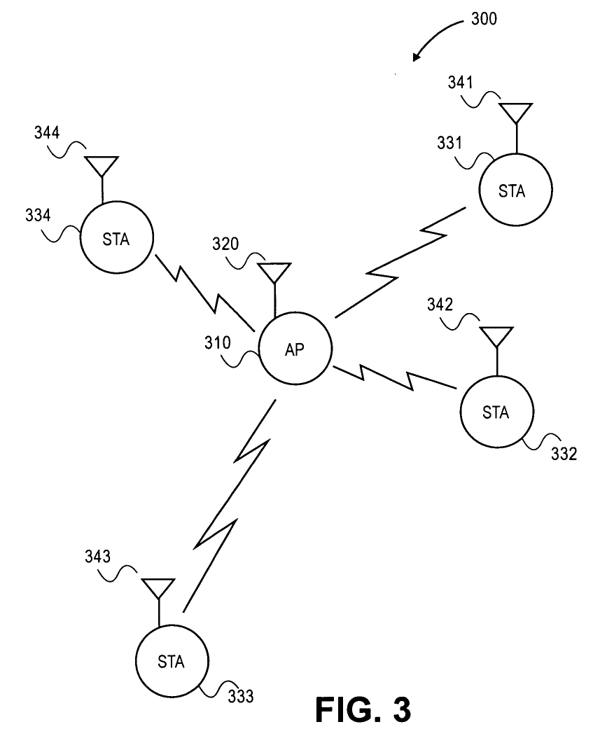

FIG. 3 shows a diagram of a wireless network in which mobile wireless devices (STAs) may scan the channels being used by the base station (AP) to communicate with the STAs, according to an embodiment of the invention. In the illustrated network 300, an AP 310 may communicate with multiple mobile wireless devices 331, 332, 333 and 334. Each device is shown with an antenna (320 for the AP and 341-344 for the STAs) through which the device may transmit and receive signals according to the protocols of the communications technology being used. The AP may receive signals transmitted by each of the STAs and may transmit signals to each of the STAs, while each of the STAs may receive signals from the AP and may transmit signals to the AP. In some embodiments at least one STA may monitor or otherwise communicate directly with at least one other STA, although the invention is not limited in this respect. Although only one antenna is shown per device, some or all of the devices may have more than one antenna. Each antenna may be of various types, such as but not limited to a dipole antenna and/or an omni-directional antenna.

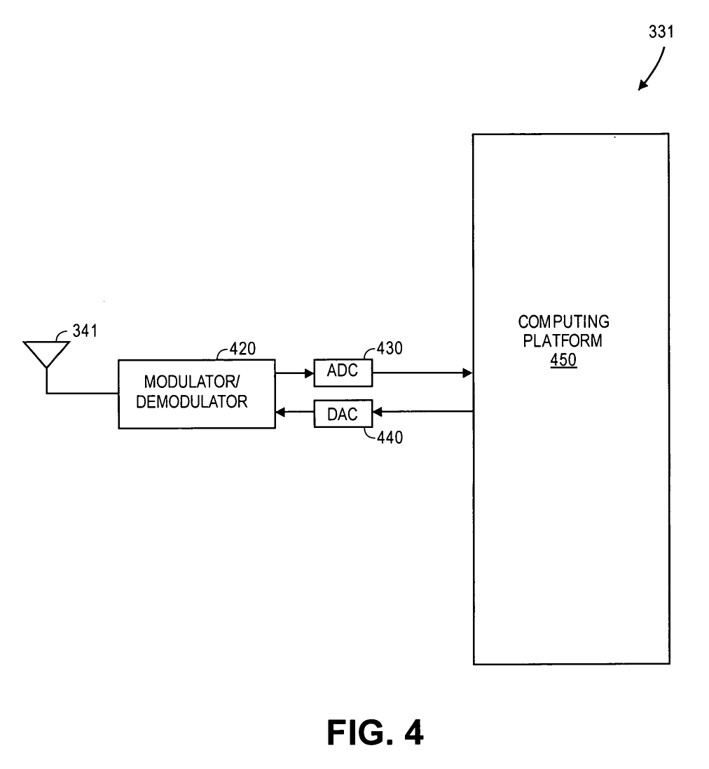

FIG. 4 shows a wireless device that may scan for available channels, according to an embodiment of the invention. Although the wireless device and its antenna are labeled 331 and 341, corresponding with an exemplary STA in FIG. 3, the drawing may also illustrate the components of any STA. In the illustrated embodiment of FIG. 4, computing platform 450 may be coupled to antenna 341 through modulator/demodulator 420, analog to digital converter (ADC) 430, and digital to analog converter (DAC) 440. The ADC and DAC may convert signals between analog and digital formats, while the modulator/demodulator may convert between the analog signals and a high frequency signal suitable for wireless communications. Other components not shown may also be included.

The foregoing description is intended to be illustrative and not limiting. Variations will occur to those of skill in the art. Those variations are intended to be included in the various embodiments of the invention, which are limited only by the spirit and scope of the appended claims.

1. An apparatus, comprising
a mobile wireless device adapted to:
scan multiple channels to determine which channels are active;
receive information on a first channel of the multiple channels indicating whether a second channel of the multiple channels is to be used with the first channel to effectively form a larger channel; and
write indicators to indicate that the first and second channels need not be scanned, responsive to the information indicating that the second channel is to be used with the first channel to effectively form a larger channel.

2. The apparatus of claim 1, wherein the mobile wireless device is further adapted to set the indicators to indicate that the first channel need not be scanned again and the second channel is unscanned, responsive to the information indicating that the second channel is not to be used with the first channel to effectively form a larger channel.

3. The apparatus of claim 1, wherein the information is contained in at least one of a beacon and a probe response.

4. The apparatus of claim 1, wherein the information further indicates how the second channel is associated with the first channel.

5. The apparatus of claim 1, wherein the first and second channels each have a bandwidth of approximately 20 megahertz, and the larger channel has a bandwidth of approximately 40 megahertz.

6. A system, comprising
a dipole antenna;
a mobile wireless device coupled to the dipole antenna and adapted to:
scan multiple channels to determine which channels are available for use;
receive information on a first channel of the multiple channels indicating whether a second channel of the multiple channels is to be used with the first channel to effectively form a larger channel; and
set indicators to indicate that the first and second channels need not be scanned, responsive to the information indicating that the second channel is to be used with the first channel to effectively form a larger channel.

7. The system of claim 6, wherein the mobile wireless device is further adapted to set the indicators to indicate that the first channel need not be scanned again and the second channel is to be scanned, responsive to the information indicating that the second channel is not to be used with the first channel to effectively form a larger channel.

8. The system of claim 6, wherein the information is contained in at least one of a beacon and a probe response.

9. The system of claim 6, wherein the information further indicates how the second channel is associated with the first channel.

10. The system of claim 6, wherein the first and second channels each have a bandwidth of approximately 20 megahertz, and the larger channel has a bandwidth of approximately 40 megahertz.

11. A method, comprising:
receiving information on a first wireless channel that the first wireless channel is available for data communications between a base station and a mobile wireless device;
determining from the information if a second wireless channel is used with the first wireless channel for said communications;
setting a first indicator to indicate that the first channel need not be scanned; and
setting a second indicator to indicate that the second channel need not be scanned, responsive to said determining that the second wireless channel is used with the first wireless channel.

12. The method of claim 11, further comprising not writing the second indicator to indicate that the second channel need not be scanned, responsive to said determining that the second wireless channel is not used with the first wireless channel.

13. The method of claim 11, wherein said receiving comprises at least one of receiving a beacon and receiving a probe response.

14. The method of claim 11, wherein said second channel is adjacent to said first channel.

15. The method of claim 11, wherein said information includes at least one item selected from the list of a channel width indicator, a control channel indicator, and an extension channel offset indicator.

16. The method of claim 11, wherein each of said first and second channels have a bandwidth of approximately 20 megahertz.

17. The method of claim 11, further comprising repeating said receiving, said determining, and said setting the first and second indicators for a third channel different than the first and second channels.

18. An article comprising
a machine-readable medium that provides instructions, which when executed by a processing platform, cause said processing platform to perform operations comprising:
receiving information on a first wireless channel that the first wireless channel is available for data communications between a base station and a mobile wireless device;
determining from the information if a second wireless channel is used with the first wireless channel for said communications;
providing a first indicator to indicate that the first channel is not to be scanned; and
providing a second indicator to indicate one of
1) that the second channel need not be scanned, responsive to said determining that the second wireless channel is used with the first wireless channel; and
2) that the second channel is unscanned, responsive to said determining that the second wireless channel is not used with the first wireless channel.

19. The article of claim 18, wherein the operation of receiving comprises at least one of receiving a beacon and receiving a probe response.

20. The article of claim 18, wherein said information includes at least one item selected from the list of a channel width indicator, a control channel indicator, and an extension channel offset indicator.

21. The article of claim 18, wherein said operations further comprise repeating said receiving, said determining, and said providing an indicator for a third channel different than the first and second channels.
